(19) United States
(12) Patent Application Publication
(10) Pub. No.: US 2007/0120788 A1
(43) Pub. Date: May 31, 2007

(54) Display devices and panel modules

(75) Inventors: Chung-Kuang Tsai, Jhudong Township (TW); Wen-Kai Shih, Taichung City (TW); Wu-Feng Liou, Tanzih Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/370,706

(22) Filed: Mar. 8, 2006

(30) Foreign Application Priority Data
Nov. 30, 2005 (TW) 94142044

(51) Int. Cl. G09G 3/36

(52) U.S. Cl. 345/87

(57) ABSTRACT

A display device comprising a glass substrate, a display array, a backlight unit, at least one first driver, a second driver, a scalar, and a timing controller. The display array is disposed on the glass substrate and comprises a plurality of pixel units. The backlight unit provides light to the display array. The at least one first driver controls the pixel units. The second driver drives the backlight unit. The scalar processes an image input signal and outputs a digital image signal. The timing controller receives the digital image signal and provides at least one control signal to the at least one first driver. The memory device stores optics and image references of the display array. The memory device is coupled to the circuit board of the at least one first driver, the circuit board of the second driver, or the glass substrate.

This application claims the benefit of Taiwan application Serial No. 94142044 filed Nov. 30, 2005, the subject matter of which is incorporated herein by reference.

### BACKGROUND OF THE INVENTION

1. Field of the Invention

The present invention relates to a display device, and in particular relates to a panel module with a memory device for storing optics and image references related to a display array.

2. Description of the Related Art

In a conventional liquid crystal display (LCD) device, a memory device, such as an electrically erasable programmable read-only memory (EEPROM), is used to store optics references and image references related to a panel module within LCD device. The memory device is disposed on a circuit board of a timing controller, a circuit board of a scalar, or a common circuit board of a timing controller and a scalar. Referring to FIG. 1, a conventional display device comprises a system module 10 and a panel module 11. The system module 10 comprises a timing controller 100 and a scalar 101, which are disposed on the same or different circuit boards. FIG. 1 shows the timing controller 100 and the scalar 101 disposed on the same circuit board 12. The panel module 11 comprises a data driver 110, a scan driver 111, a backlight unit 112, a driver 113 for driving the backlight unit 112, and a display array 114. The driver 113 is generally an inverter. Referring to FIG. 1, the data driver 110 is coupled to a circuit board 13, the scan driver 111 is coupled to a circuit board 14, and the driver 113 is coupled to a circuit board 15. The display device 1 further comprises a memory device 16, which is disposed on the circuit board 12 and stores optics references and image references related to the panel module 11. The optics and image references comprise white balance references, color regulation reference, response time of liquid crystal molecules, and the like.

The disposition of the memory device 16, however, causes problems in collocation of the system module 10 and the panel module 11. The panel module 11 must operate with a system module of the particular specification, so that applications of the panel module 11 can be greatly reduced. Moreover, after the optics and image references are optimized and stored in the memory device 16, the optics and image references are required to be regulated again in the system setting process, thereby increasing the complexity of the panel module manufacture.

### BRIEF SUMMARY OF THE INVENTION

According to one embodiment of the present invention, there is provided a display device comprising a glass substrate, a display array, a backlight unit, at least one first driver, a second driver, a scalar, a timing controller, a first circuit board, and a second circuit board. The display array is disposed on the glass substrate and comprises a plurality of pixel units. The backlight unit provides light to the display array. The at least one first driver controls the pixel units. The second driver drives the backlight unit. The scalar processes an image input signal and outputs a digital image signal. The timing controller is disposed on the first circuit board and receives the digital image signal and provides at least one control signal to the at least one first driver. The memory device is disposed on the second circuit board and stores optics and image references of the display array.

In some embodiments of the present invention, the at least one first driver is coupled to the second circuit board. In other embodiments, the second driver is coupled to the second circuit board.

According to another embodiment of the present invention, there is provided a display device comprising a glass substrate, a display array, a backlight unit, at least one first driver, a second driver, a scalar, and a timing controller. The display array is disposed on the glass substrate and comprises a plurality of pixel units. The backlight unit provides light to the display array. The at least one first driver controls the pixel units. The second driver drives the backlight unit. The scalar processes an image input signal and outputs a digital image signal. The timing controller receives the digital image signal and provides at least one control signal to the at least one first driver. The memory device stores optics and image references of the display array and is disposed on the glass substrate.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a conventional display device;

FIG. 2 depicts an exemplary embodiment of a display device;

FIGS. 3a and 3b depict the coupling of the data driver and the scan driver of FIG. 2;

FIG. 4 depicts the timing controller and the scalar of FIG. 2 disposed on the different circuit boards;

FIG. 5 depicts an exemplary embodiment of a display device;

FIG. 6 depicts an exemplary embodiment of a display device; and

FIG. 7 depicts an exemplary embodiment of a display device.

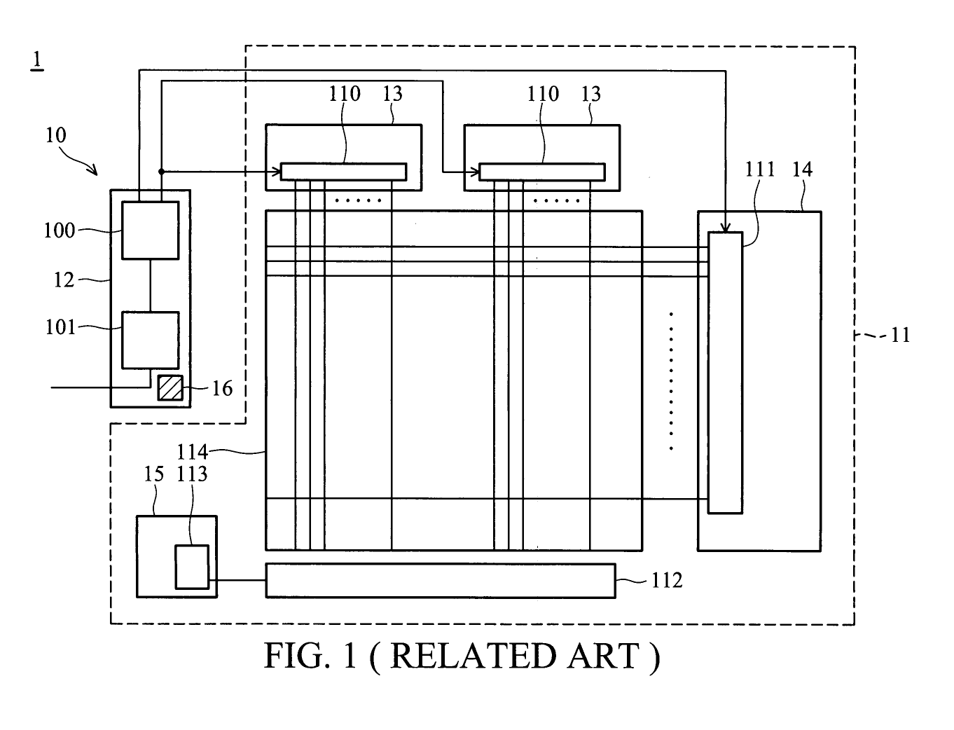

### DETAILED DESCRIPTION OF THE INVENTION

The following description is of the best-contemplated mode of carrying out the invention. This description is made for the purpose of illustrating the general principles of the present invention and should not be taken in a limiting sense. The scope of the present invention is best determined by the appended claims.

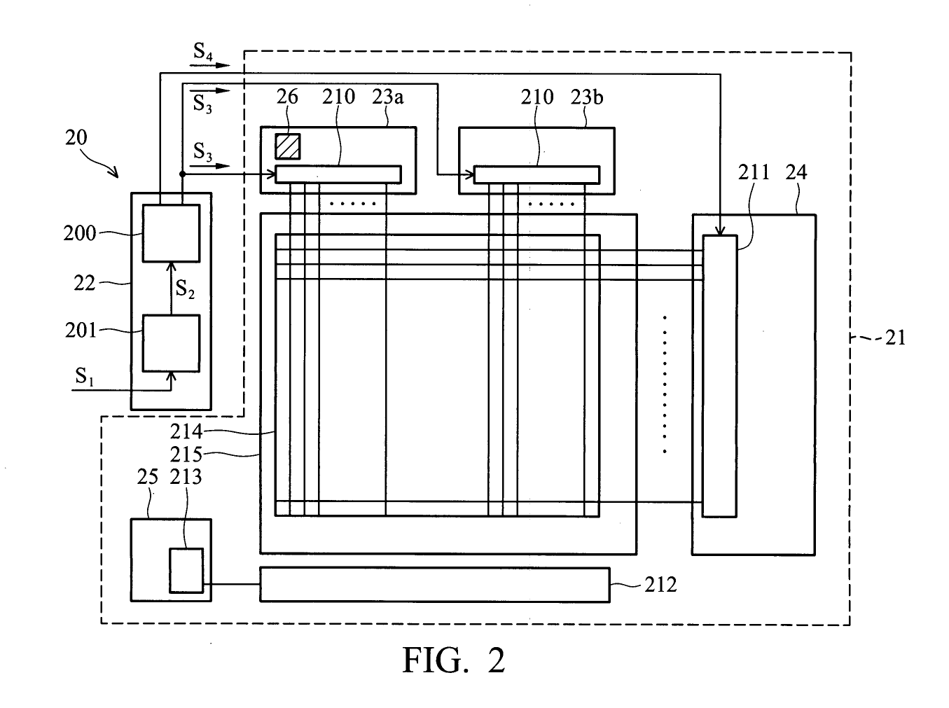

Display devices are provided. In an exemplary embodiment of the present invention, as shown in. FIG. 2, a display device 2 comprises a system module 20 and a panel module 21. The system module 20 comprises a timing controller 200 and a scalar 201, which are disposed on the same or different circuit boards. FIG. 2 shows the timing controller 200 and the scalar 201 disposed on the same circuit board 22. The panel module 21 comprises a data driver 210, a scan driver 211, a backlight unit 212, a driver 213 for driving the backlight unit 212, and a display array 214. The driver 213 can be an inverter. Referring to FIG. 2, the data driver 210 is coupled to a circuit board 23a or 23b or to the circuit boards 23a and 23b. The scan driver 211 is coupled to a circuit board 24, and the driver 213 is coupled to a circuit board 25. The display device 2 further comprises a memory device 26, which stores characteristic references related to the panel module 21. The characteristic references comprise optics and image references of the display array 214, such as white balance, color regulation, response time of liquid crystal molecules, and the like. Note that the memory device 26 is disposed on the circuit board 23a or 23b. In FIG. 2, the memory device 26 is disposed on the circuit board 23a.

In the system module 20, the scalar 201 receives an image input signal S₁. After processing the image input signal S₁, the scalar 201 outputs a digital image signal S₂. The timing controller 200 receives the digital image signal S₂ and provides control signals to the data driver 210 and the scan driver 211, respectively.

In the display module 21, the display array 214 comprises a plurality of pixel units disposed on rows and columns for displaying images. The display array 214 is disposed on a glass substrate 215. The scan driver 211 sequentially provides scan signals to the display array 14 to tune on the pixels unit on each row. The data driver 210 provides image signals to the turned-on pixel units to display images. The driver 213 drives the backlight unit 212 to provide light to the display array 214.

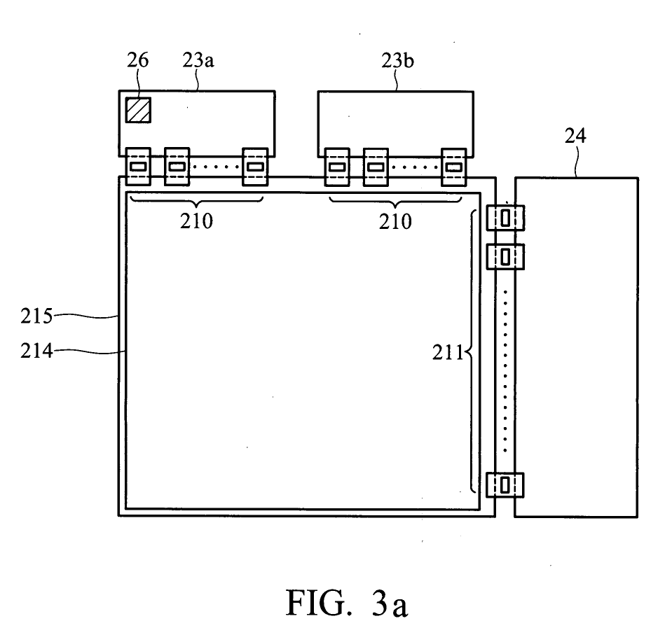

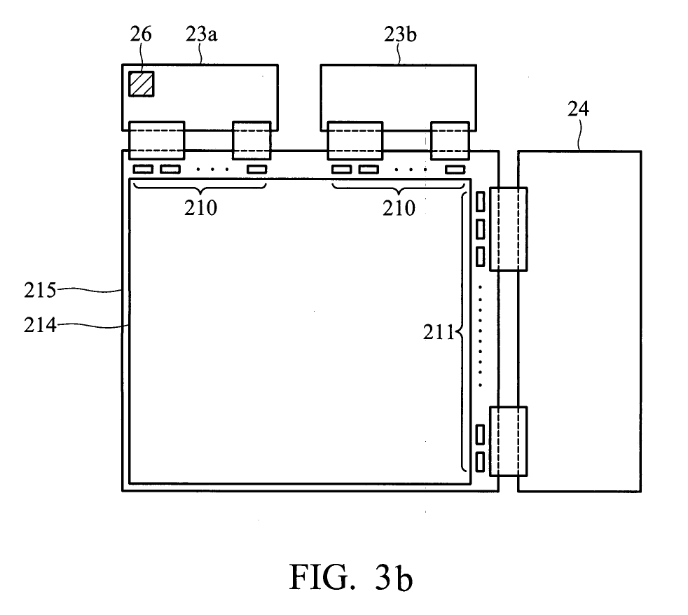

FIG. 3a depicts an example of the coupling of the data driver and the scan driver in FIG. 2. Referring to FIG. 3a, the data driver 210 is coupled to the circuit board 23a or 23b or to the circuit boards 23a and 23b by chip-on-film (COF). The scan driver 211 is also coupled to the circuit board 24 by COF.

FIG. 3b depicts another example of the coupling of the data driver and the scan driver in FIG. 2. Referring to FIG. 3b, the data driver 210 is coupled to the circuit board 23a or 23b or to the circuit boards 23a and 23b by chip-on-glass (COG). The scan driver 211 is also coupled to the circuit board 24 by COG. The same coupling of the data driver 210 and the scan driver 211 is not a limitation. In practice, it is possible to use COF for one driver, and to use COG for the other driver. FIGS. 3a and 3b only show the data driver 210, the scan driver 211, the display array 214, the glass substrate 215 and the memory device 26, and the disposition of the other elements is the same as that shown in FIG. 2.

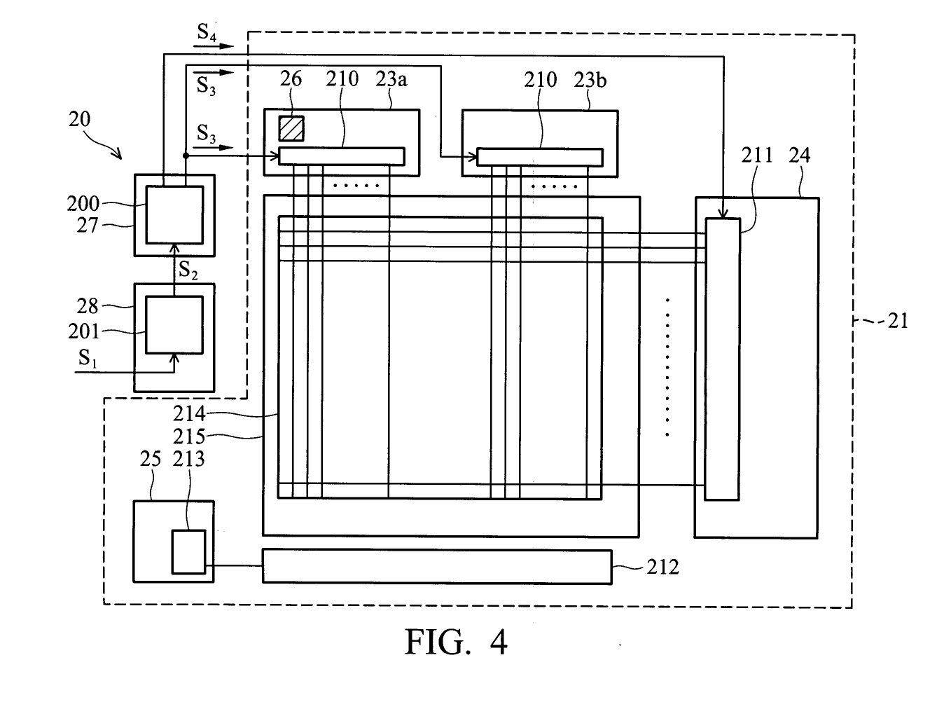

FIG. 4 depicts the timing controller 200 and the scalar 201 disposed on different circuit boards. In FIG. 4, the timing controller 200 is disposed on a circuit board 27, and the scalar 201 is disposed on another circuit board 28.

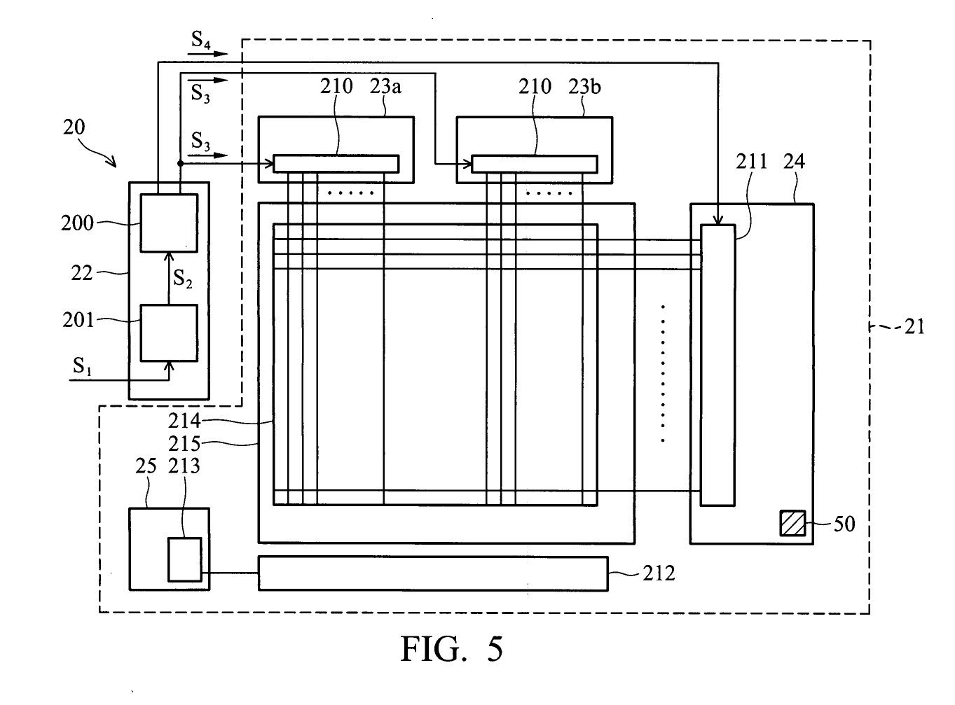

According to another exemplary embodiment of the present invention, a display device 5 comprising a system module 20 and a panel module 21 is shown in FIG. 5. The system module 20 comprises a timing controller 200 and a scalar 201, which are disposed on the same or different circuit boards. FIG. 5 shows the timing controller 200 and scalar 201 disposed on the same circuit board 22. The panel module 21 comprises a data driver 210, a scan driver 211, a backlight unit 212, a driver 213 for driving the backlight unit 212, and a display array 214. The display array 214 is disposed on the glass substrate 215. The driver 213 can be an inverter. Referring to FIG. 5, the data driver 210 is coupled to a circuit board 23a or 23b or to the circuit boards 23a and 23b. The scan driver 211 is coupled to a circuit board 24, and the driver 213 is coupled to a circuit board 25. The display device 5 further comprises a memory device 50, which stores characteristic references related to the panel module 21. The characteristic references comprise optics and image references of the display array 214, such as white balance, color regulation, response time of liquid crystal molecules, and the like. Note that the memory device 50 is disposed on the circuit board 24.

In FIGS. 2 and 5, the elements with the same labels perform the same operations. Moreover, the elements with the same labels use the same coupling, as shown in FIGS. 3a and 3b.

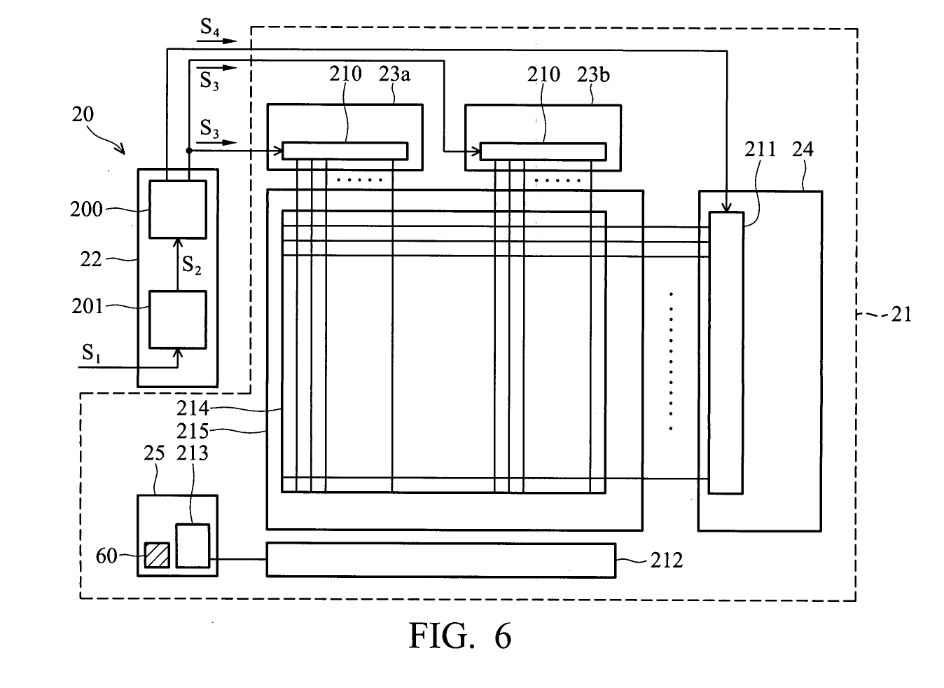

According to an exemplary embodiment of the present invention, a display device 6 comprising a system module 20 and a panel module 21 is shown in FIG. 6. The system module 20 comprises a timing controller 200 and scalar 201 which are disposed on the same or different circuit boards. FIG. 6 shows the timing controller 200 and the scalar 201 disposed on the same circuit board 22. The panel module 21 comprises a data driver 210, a scan driver 211, a backlight unit 212, a driver 213 for driving the backlight unit 212, and a display array 214. The display array 214 is disposed on the glass substrate 215. The driver 213 can be an inverter. Referring to FIG. 6, the data driver 210 is coupled to a circuit board 23a or 23b or to the circuit boards 23a and 23b. The scan driver 211 is coupled to a circuit board 24, and the driver 213 is coupled to a circuit board 25. The display device 6 further comprises a memory device 60, which stores characteristic references related to the panel module 21. The characteristic references comprise optics and image references of the display array 214, such as white balance, color regulation, response time of liquid crystal molecules, and similar. Note that the memory device 60 is disposed on the circuit board 25.

In FIGS. 2 and 6, the elements with the same labels perform the same operations. Moreover, the elements with the same labels use the same coupling, as shown in FIGS. 3a and 3b.

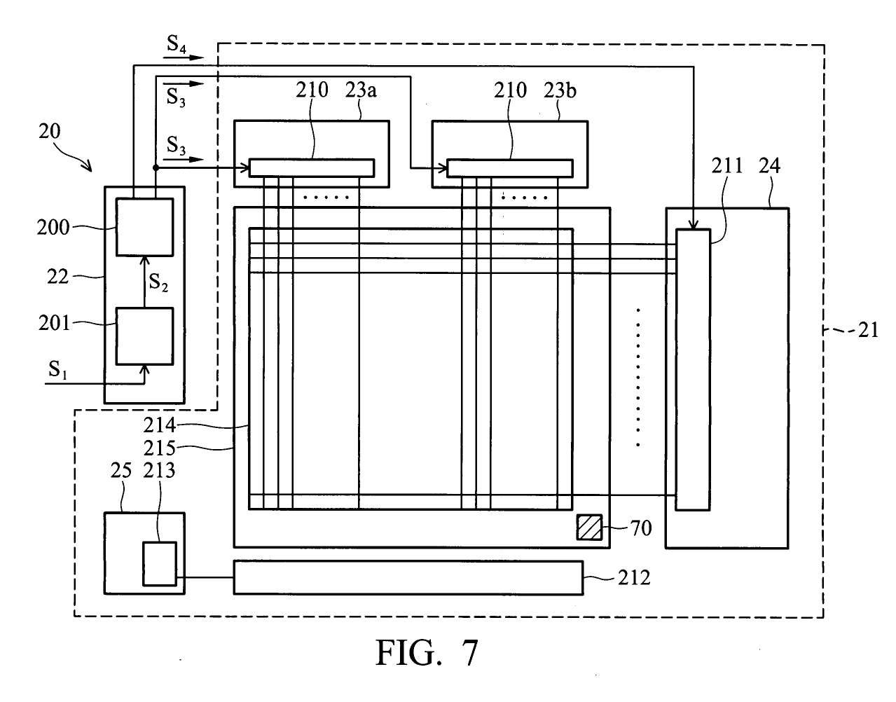

In an exemplary embodiment of the present invention, a display device 7 comprising a system module 20 and a panel module 21 is shown in FIG. 7. The system module 20 comprises a timing controller 200 and a scalar 201 which are disposed on the same or different circuit boards. FIG. 7 shows the timing controller 200 and scalar 201 disposed on the same circuit board 22. The panel module 21 comprises a data driver 210, a scan driver 211, a backlight unit 212, a driver 213 for driving the backlight unit 212, and a display array 214. The display array 214 is disposed on the glass substrate 215. The driver 213 can be an inverter. Referring to FIG. 7, the data driver 210 is coupled to a circuit board 23a or 23b or to the circuit boards 23a and 23b. The scan driver 211 is coupled to a circuit board 24, and the driver 213 is coupled to a circuit board 25. The display device 7 further comprises a memory device 70, which stores characteristic references related to the panel module 21. The characteristic references comprise optics and image references of the display array 214, such as white balance, color regulation, response time of liquid crystal molecules, and similar. Note that the memory device 70 is disposed on the glass substrate 215.

In FIGS. 2 and 7, the elements with the same labels perform the same operations. Moreover, the elements with the same labels use the same coupling, as shown in FIGS. 3a and 3b.

As shown in FIGS. 2, 5, 6, and 7, a memory device storing optics and image references is disposed on the circuit board to which the data driver is coupled, the circuit board to which the scan driver is coupled, the circuit board to which the backlight driver is coupled, or the glass substrate of the display array, instead of the circuit board to which the timing controller is coupled. In other words, the memory device is disposed on a circuit board of the panel module or the glass substrate, but not on a circuit board of the system module. Thus, the panel module with the memory device is not limited to a system module of the particular specification. In the system setting process, it is not necessary for the optics and image references to be regulated again, thereby decreasing the number of processes required during panel module manufacture.

While the present invention has been described by way of example and in terms of the preferred embodiments, it is to be understood that the present invention is not limited to the disclosed embodiments. Rather, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display device having a first circuit board and a second circuit board, comprising:
a glass substrate;
a display array, disposed on the glass substrate, having a plurality of pixel units;
a backlight unit for providing light to the display array;
at least one first driver for controlling the pixel units;
a second driver for driving the backlight unit;
a scalar for processing an image input signal and outputting a digital image signal;
a timing controller, disposed on the first circuit board, for receiving the digital image signal and providing at least one control signal to the at least one first driver; and
a memory device, disposed on the second circuit board, for storing optics and image references of the display array.

2. The display device as claimed in claim 1, wherein the at least one first driver comprises a data driver.

3. The display device as claimed in claim 1, wherein the at least one first driver comprises a scan drive.

4. The display device as claimed in claim 1, further comprising a third circuit board, wherein the scalar is disposed on the third circuit board.

5. The display device as claimed in claim 1, wherein the scalar and the timing controller are disposed on the first circuit board.

6. The display device as claimed in claim 1, wherein the at least one first driver is coupled to the second circuit board.

7. The display device as claimed in claim 1, wherein the second driver is coupled to the second circuit board

8. The display device as claimed in claim 1, wherein the optics and image references comprise at least one of white balance references, color regulation reference, and response time of liquid crystal molecules.

9. A panel module, comprising:
a glass substrate;
a display array disposed on the glass substrate and comprising a plurality of pixel units;
a backlight unit providing light to the display array;
at least one first driver controlling the pixel units;
a second driver driving the backlight unit; and
a memory device storing optics and image references of the display array and disposed on the glass substrate.

10. The panel module as claimed in claim 9, wherein the at least one first driver is a data driver.

11. The panel module as claimed in claim 9, wherein the at least one first driver is a scan driver.

12. The panel module as claimed in claim 9, wherein the optics and image references comprise at least one of white balance references, color regulation reference, response time of liquid crystal molecules.

13. The panel module as claimed in claim 9, wherein the at least one first driver is coupled to the first circuit board by chip-on-film (COF).

14. The panel module as claimed in claim 9, wherein the at least one first driver is coupled to the first circuit board by chip-on-glass (COG).

15. The panel module as claimed in claim 9, further comprising:
a scalar for processing an image input signal and outputting a digital image signal; and
a timing controller for receiving the digital image signal and providing at least one control signal to the at least one first driver.

16. A panel module, comprising:
a first circuit board;
a second circuit board;
a display array having a plurality of pixel units;
a backlight unit for providing light to the display array;
at least one first driver, coupled to the first circuit board, for controlling the pixel units and;
a second driver, coupled to the second circuit board, for driving the backlight unit; and
a memory device for storing optics and image references of the display array;
wherein the memory device is disposed on one of the first and second circuit boards.

17. The panel module as claimed in claim 16, wherein the at least one first driver comprises a data driver.

18. The panel module as claimed in claim 16, wherein the at least one first driver comprises a scan drive.

19. The panel module as claimed in claim 16, wherein the optics and image references comprise at least one of white balance references, color regulation reference, response time of liquid crystal molecules.

20. The panel module as claimed in claim 16, wherein the at least one first driver is coupled to the first circuit board by chip-on-film (COF).

21. The panel module as claimed in claim 16, wherein the at least one first driver is coupled to the first circuit board by chip-on-glass (COG).
